(19) United States
(12) Patent Application Publication
(10) Pub. No.: US 2023/0299499 A1
(43) Pub. Date: Sep. 21, 2023

(54) WIRELESS THROUGHPUT VIA BEAM REFLECTION REDUCTION

(71) Applicant: AT&T Intellectual Property I, L.P., Atlanta, GA (US)

(72) Inventors: Jianchun Zhou, Bellevue, WA (US); Yakun Gao, Suwanee, GA (US); Ratish Upadhyay, Frisco, TX (US); Peter Doyle, McKinney, TX (US)

(21) Appl. No.: 17/655,108

(22) Filed: Mar. 16, 2022

(51) Int. Cl. H01Q 17/00; H04B 7/0413; H04W 16/28

(52) U.S. Cl. CPC H01Q 17/001; H04B 7/0413; H04W 16/28

(57) ABSTRACT

Techniques for improved wireless throughput via beam reflection reduction are provided. A wireless communication device can include a device enclosure that at least partially encompasses an interior of the wireless communication device, the device enclosure comprising a cover assembly that defines a surface of the wireless communication device, wherein the cover assembly is composed of at least a first material; an antenna embedded within the interior of the wireless communication device substantially adjacent to the cover assembly, wherein the antenna is situated at a position relative to the cover assembly; and an aperture formed into the cover assembly at the position, wherein the aperture is not composed of the first material. Alternatively, the aperture can be coated with a non-reflective material that is distinct from the first material.

### TECHNICAL FIELD

The present disclosure relates to wireless communication devices, and, in particular, to techniques for improving the throughput of a wireless communication device via reducing radio beam reflection.

### BACKGROUND

In telecommunications, beamforming is a technique by which multiple antennas, e.g., antenna elements of an antenna panel or array, facilitate directional transmission of a signal by controlling the interference created by the respective antennas. Among other techniques, beamforming is the foundation of massive multiple-input multiple-output (MIMO) communication, which will play an instrumental role in the advancement of wireless communication technology, e.g., to Fifth Generation (5G) networks and beyond. While beamforming utilizes line-of-sight (LOS) single paths between a transmitter and receiver, MIMO benefits from multiple non-line-of-sight (NLOS) paths from the transmitter to the receiver.

### DESCRIPTION OF DRAWINGS

FIG. 1 is a diagram depicting a wireless communication device with improved performance via reduction in radio beam reflection in accordance with various aspects described herein.

FIG. 2 is a diagram depicting antenna locations for an example wireless communication device in accordance with various aspects described herein.

FIGS. 3-4 are diagrams depicting signal quality metrics observed by the wireless communication device of FIG. 2 over a time period in accordance with various aspects described herein.

FIGS. 5-7 are diagrams depicting cross-sectional views of respective implementations of a wireless communication device with beam reflection reduction in accordance with various aspects described herein.

FIG. 8 is a diagram depicting another wireless communication device with improved performance via reduction in radio beam reflection in accordance with various aspects described herein.

FIGS. 9-10 are diagrams depicting respective antenna panels that can be utilized by a wireless communication device in accordance with various aspects described herein.

FIG. 11 is a diagram depicting an additional wireless communication device with improved performance via reduction in radio beam reflection in accordance with various aspects described herein.

FIG. 12 is a diagram depicting a partially exploded view of a further wireless communication device with improved performance via reduction in radio beam reflection in accordance with various aspects described herein.

FIG. 13 is a flow diagram of a method that facilitates improvement in wireless communication device performance via reduction in radio beam reflection in accordance with various aspects described herein.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring certain aspects.

In an aspect, a wireless communication device as described herein can include a device enclosure that at least partially encompasses an interior of the wireless communication device, the device enclosure including a cover assembly that defines a surface of the wireless communication device, where the cover assembly is composed of at least a first material. The wireless communication device can further include an antenna embedded within the interior of the wireless communication device substantially adjacent to the cover assembly, where the antenna is situated at a position relative to the cover assembly. The wireless communication device can also include an aperture formed into the cover assembly at the position, where the aperture is not composed of the first material.

In another aspect, a wireless communication device as described herein can include a device enclosure that at least partially encompasses an interior of the wireless communication device, where the device enclosure defines a perimeter of the wireless communication device. The wireless communication device can also include a directional antenna embedded within the wireless communication device and positioned inside the device enclosure at a first distance from the perimeter of the wireless communication device, where the directional antenna operates according to a first wireless communication technology. The wireless communication device can additionally include a multiple-input multiple-output (MIMO) antenna, distinct from the directional antenna, positioned inside the device enclosure at a second distance, greater than the first distance, from the perimeter of the wireless communication device, where the MIMO antenna operates according to a second wireless communication technology that is distinct from the first wireless communication technology.

In a further aspect, a method as described herein can include obtaining, by a wireless communication device, information relating to a beamformed signal to be received by an antenna of the wireless communication device, where the antenna is embedded in the wireless communication device at a position relative to a covering of the wireless communication device. The method can also include receiving, by the antenna through an aperture formed into the covering of the wireless communication device at the position, the beamformed signal without reflecting, by the covering of the wireless communication device, the beamformed signal.

Various aspects described herein facilitate improvement in the performance of a wireless communication device, e.g., in terms of throughput, signal quality and/or stability, or the like, by reducing the amount and/or intensity of radio signals reflected away from the device and, by extension, reducing the amount and/or intensity of radio signals reflected from other devices that are observed by the device. As used herein, a “wireless communication device” refers to any device that is capable of communicating with other devices over a wireless communication network (e.g., a Fifth Generation (5G), Sixth Generation (6G) or other cellular network, a Wi-Fi network, etc.). Examples of wireless communication devices in which various aspects described herein can function include, but are not limited to, the following: mobile phones; tablet, laptop or desktop computers; unmanned aerial vehicles (UAVs) or drones; augmented reality (AR) and/or virtual reality (VR) headsets; Internet of Things (IoT) devices; vehicle communication systems, such as those utilized by human-operated and/or autonomous vehicles; and/or any other suitable device, either presently existing or developed in the future.

As noted above, beamforming is the foundation of massive MIMO communication, which can be utilized to provide improved throughput and/or capacity in a communication system. For instance, in a 5G network, each network sector can utilize a number of beams from approximately 64 to approximately 196. It is noted that other beam configurations, including any suitable number of beams, could also be used. As further noted above, beamforming benefits from having LOS single paths between a transmitter and receiver, e.g., between a user equipment (UE) and a gNodeB (gNB) in a 5G network, whereas NLOS multipaths benefit MIMO. While single-path communication, such as that associated with beamforming, works well under minimal to no beam reflection, beamforming performance is degraded in environments with significant reflection due to beam pollution and interference caused by reflected radio beams. Accordingly, it is desirable to reduce beam reflection in order to improve network performance, e.g., in 5G and/or other networks.

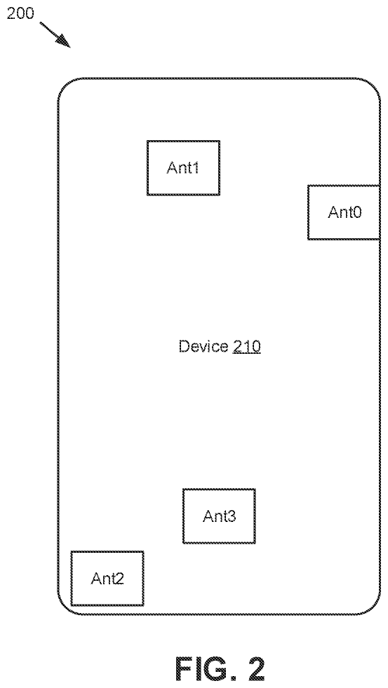

Additionally, the materials utilized in the construction of a wireless communication device can have a significant impact on the amount of beam reflection produced and/or encountered by the device. As an example, many existing high-end smartphones utilize glass for both the front and back covers of the phone due to its desirable appearance. For instance, some devices utilize a “glass sandwich” design in which glass panels are applied to the front and back of the phone while the sides of the phone are constructed from metal or another material. However, these glass device surfaces can reflect radio beams under various circumstances, resulting in significant degradation in downlink (DL) throughput. An example of DL throughput degradation that can be caused by radio beam reflection (e.g., radio beam reflection from a glass device cover) is described in further detail below with respect to FIGS. 2-4.

In view of at least the above, various implementations described herein facilitate reduction in beam reflection, e.g., via absorbing surface materials and/or other means, to improve throughput and overall device performance. The implementations described herein can aid devices in realizing the full potential of C-Band, millimeter wave (mmWave), and/or any other future spectrum using beamforming, both domestically and globally.

With reference now to the drawings, various views of example generic wireless communication devices are provided. It is noted that, unless explicitly stated otherwise, the devices depicted in the drawings are not intended to represent any specific type and/or category of device, as a wireless communication device as defined herein can include any suitable device capable of wireless communication. Further, it is noted that the drawings are not drawn to scale, either within a single drawing or between different drawings.

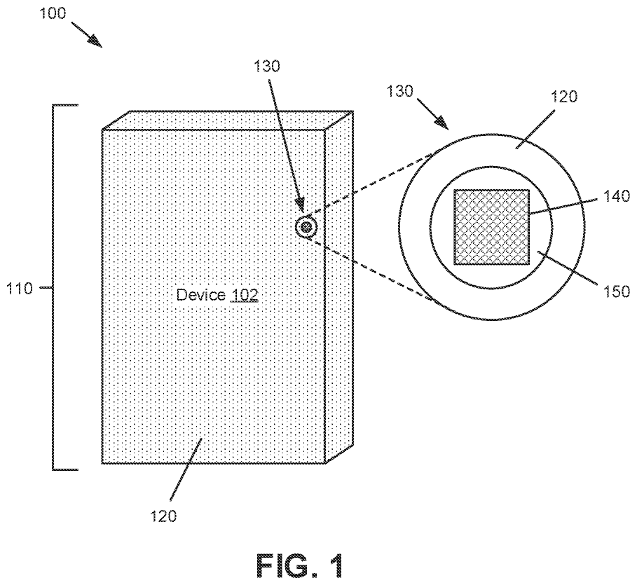

Referring first to FIG. 1, a diagram 100 depicting a wireless communication device 102 (also referred to herein as simply a “device” for brevity) with improved performance via reduction in radio beam reflection is presented. The device 102 includes a device enclosure 110, which can at least partially encompass an interior of the device 102. The interior of the device 102 can include hardware components such as processors, memory, input/output (I/O) devices, buses and/or interfaces, antennas and/or other transceiver elements, and/or other components that are housed within the device 102 via the device enclosure 110. While the device enclosure 110 is illustrated in diagram 100 as rectangular in shape, it is noted that the device 102, and/or its enclosure 110, can be of any suitable shape in addition to, or in place of, the illustrated rectangular shape.

As further shown in diagram 100, the device enclosure 110 includes a cover assembly 120 that defines a surface (edge, face, etc.) of the device 102. In an aspect, the cover assembly 120 can be composed of at least a first material, e.g., glass and/or other materials. In the example shown in diagram 100, the cover assembly 120 is composed of a same material as the remainder of the device enclosure 110, as denoted by the common shading on the respective surfaces of the device 102. It is noted, however, that the cover assembly 120 could be composed of a different material than that of other portions of the device enclosure 110. For instance, for a glass sandwich design as described above, the cover assembly 120 can be composed of glass while other surfaces of the device enclosure 110 can be composed of different materials, such as metal or plastic.

As shown in detail region 130 of diagram 100, the device 102 can include an antenna 140, e.g., a directional antenna and/or beamforming antenna, that is embedded and/or otherwise placed substantially adjacent to the cover assembly 120. As used herein, “substantially adjacent” refers to adjacency in absolute terms, e.g., physical adjacency, as well as relative adjacency, e.g., positioning such that no other objects are placed in between a pair of relatively adjacent objects, whether or not the relatively adjacent objects are physically adjacent. While only a single antenna 140 is shown in diagram 100, it is noted that the device 102 could have any number of antennas 140 arranged in any suitable configuration.

In an aspect, the antenna 140 can be of a size generally associated with C-Band and/or mmWave antennas in the art, e.g., on the order of millimeters, and/or other suitable sizes. As further shown by diagram 100, the antenna 140 is situated at a given position relative to the cover assembly 120, e.g., the position shown by detail region 130.

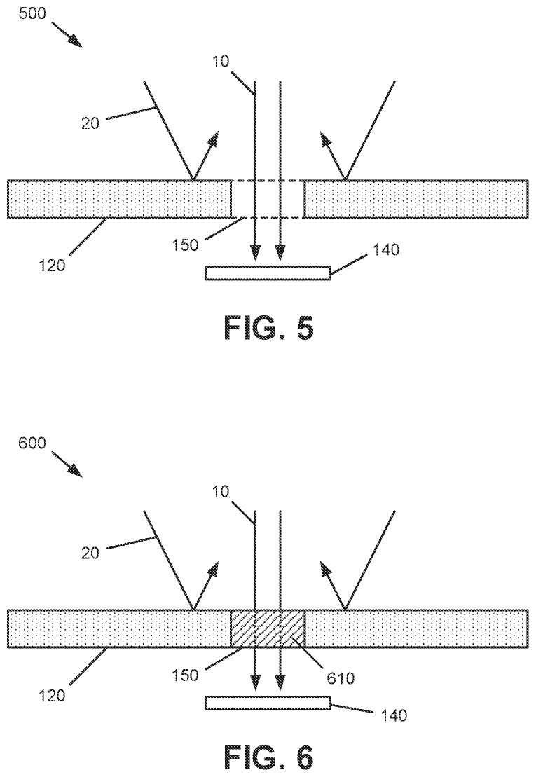

As noted above, a cover assembly 120 composed of glass and/or other reflective materials can cause radio beam reflection, which can degrade the performance of the antenna 140. To mitigate this reflection, the device 102 shown in diagram 100 includes an aperture 150 formed into the cover assembly 120 at the position of the antenna 140 that is not composed of the reflective material(s) of the cover assembly 120, as shown in detail region 130. As used herein, the term “aperture” refers to a pinhole or other opening formed into a solid surface, e.g., by etching, carving, and/or any other suitable technique(s). In one implementation, the aperture 150 can be an opening that exposes the antenna 140 to an environment surrounding the device 102. In other implementations, the aperture 150 can be filled and/or covered with non-reflective materials to facilitate absorption of reflected radio beams at the position of the antenna 140. Respective example implementations of the aperture 150 are described in further detail below with respect to FIGS. 5-7.

In an implementation as shown by detail region 130 of diagram 100, the aperture 150 formed into the cover assembly 120 can be approximately equal in size to the antenna 140 situated below the aperture plus or minus an allowance or tolerance. In some implementations, in order to maintain the appearance of the overall cover assembly 120, the size of the aperture 150 can be limited to an overall size of the antenna 140 plus a small additional area, e.g., such that the aperture 150 does not extend beyond the antenna 140 by further than the length of an edge (e.g., a longest edge, a shortest edge, etc.) of the antenna 140. Other aperture sizes are also possible.

Further, while the aperture 150 shown in diagram 100 is round in shape, it is noted that the aperture 150 can be of any suitable shape. For instance, the aperture 150 could be square and/or otherwise polygonal in shape, e.g., by carving or etching straight edges into the cover assembly 120 that define the respective edges of the aperture 150. Other shapes could also be used.

Turning now to FIGS. 2-4, performance data corresponding to an example wireless communication device 210 as measured at respective device positions are illustrated. With reference first to FIG. 2, a simplified illustration of the device 210 is shown by diagram 200. Here, the device 210 is a glass-backed smartphone having 5G antennas Ant0, Ant1, Ant2, and Ant3 in relative locations as marked on diagram 200.

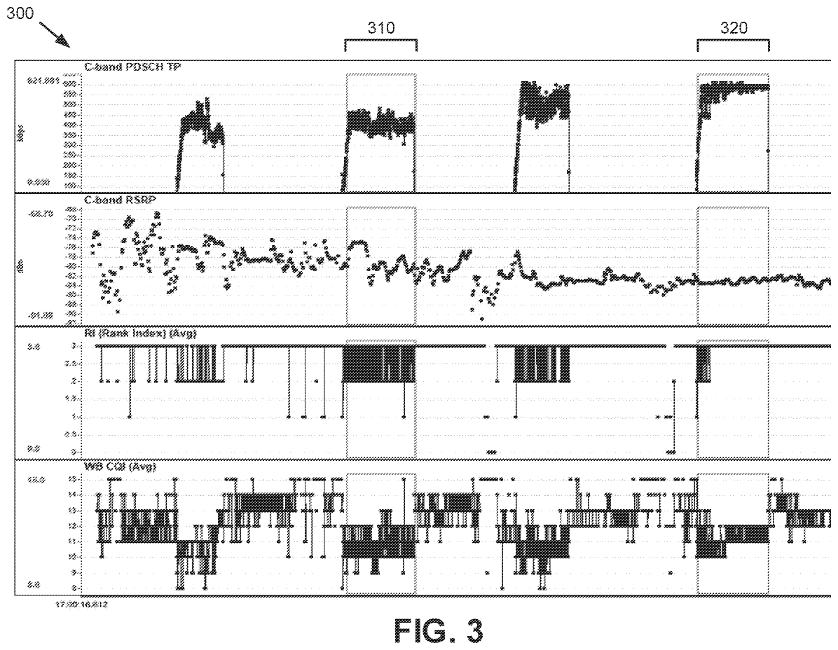

Diagram 300 in FIG. 3 illustrates respective signal quality measurements for the device 210. In order from top to bottom, diagram 300 illustrates physical downlink shared channel (PDSCH) throughput (TP), reference signal received power (RSRP), rank index (RI), and channel quality indicator (CQI) data for the device 210 over a time period. Further, region 310 in diagram 300 corresponds to a time at which the device 210 was mounted on a vehicle windshield, while region 320 corresponds to a time at which the device 210 was placed on an armrest in the vehicle.

As shown by diagram 300, the device 210 experienced a throughput degradation of approximately 30 percent at the windshield position compared to the armrest position. Additionally, diagram 300 shows that the device 210 observed a poor and fluctuating signal to noise ratio (SNR) at the windshield position, leading to a reduction in RI, e.g., from an RI of 3 to an RI between 2 and 3. These differences in signal quality between the device 210 being positioned at a vehicle windshield, as opposed to a device armrest, are due to reflection of C-Band radio beams on the glass back surface of the device 210. More particularly, at the windshield position, the device 210 receives increased interference from reflection, resulting in a low SINR. In contrast, the absorbing material surrounding the device 210 at the armrest position reduces the interference and improves SINR.

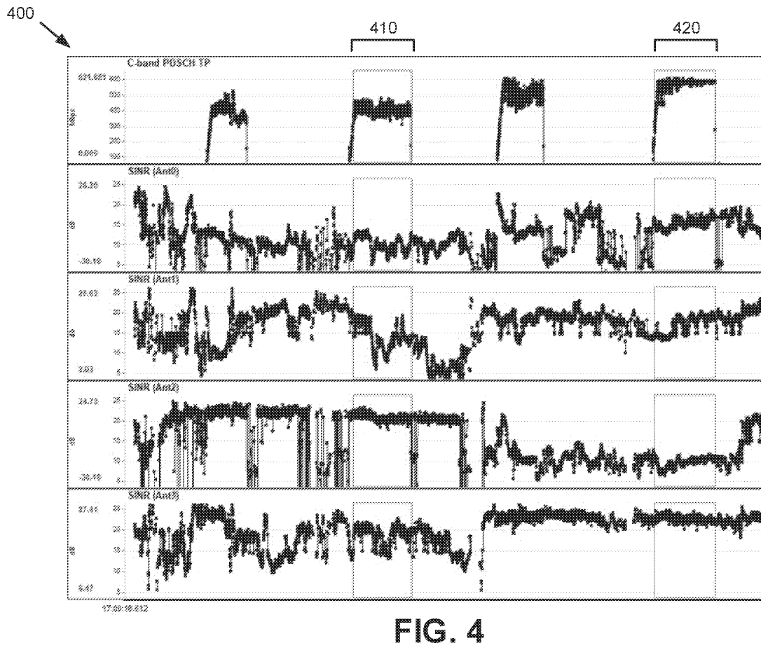

Turning to diagram 400 in FIG. 4, signal to interference plus noise ratio (SINR) data for the individual antennas Ant0-Ant3 of the device 210 are illustrated for the same time period depicted in diagram 300. Similar to FIG. 3, region 410 corresponds to the device 210 being placed in the windshield position and region 420 corresponds to the device being placed in the armrest position.

As shown by diagram 400, SINR fluctuation and degradation at the windshield position was more significant for antennas Ant1 and Ant3 than for Ant0 and Ant2. This is due to Ant1 and Ant3 being underneath the glass back cover of the device 210 while Ant0 and Ant2 are positioned closer to the less-reflective metal edges of the device 210. It is noted that although the SINR of Ant2 is lower at the armrest position as compared to the windshield position, the overall performance of the device 210 is nonetheless better at the armrest position. This is due to fluctuating SINR having a larger impact on device performance than low SINR. More particularly, fluctuations in SINR result from multiple paths or interference from neighboring beams or cells, which adversely impact device performance to a greater degree than low signal strength.

To summarize diagrams 300 and 400, the cause of the performance degradation of device 210 at the windshield position is beam reflection by the glass back of the device. Various aspects as described herein mitigate this beam reflection, facilitating improved device performance even for devices with reflective surfaces.

With reference next to FIG. 5, diagram 500 depicts a simplified cross-sectional view of an example wireless communication device, e.g., device 102 shown in FIG. 1. Diagram 500 depicts a cover assembly 120 of a wireless communication device that is composed of a reflective material, e.g., glass or the like. As further shown by diagram 500, an aperture 150 is formed into the cover assembly 120 at the position of an antenna 140 that is located in the interior of the device. Here, the aperture is an opening in the cover assembly 120 that exposes the antenna 140 to air, e.g., in the environment of the device. As a result, radio beams 10 intended for the antenna 140 can reach the antenna 140 through the air gap defined by the aperture 150. As further shown by diagram 500, reflected radio beams 20, which are distinct from the radio beams 10 intended for the antenna 140, are mitigated at the position of the antenna 140 due to the aperture 150. Also due to the aperture, the radio beams 10 intended for the antenna 140 are not reflected by the cover assembly 120.

Turning now to FIG. 6, diagram 600 depicts a simplified cross-sectional view of another implementation of an example wireless communication device, e.g., device 102 shown in FIG. 1. Repetitive description of like elements employed in other embodiments described herein is omitted for brevity. As shown in diagram 600, the aperture 150 formed into the cover assembly 120 of the device is filled with a fill layer 610 of a material that is different from the material(s) of which the cover assembly 120 is composed. By way of example, the cover assembly 120 can be composed of a reflective material such as glass, and the fill layer 610 of the aperture 150 can be composed of a less reflective material, such as fiberglass, plastic, and/or other suitable materials having lower reflectivity than the reflectivity of the material(s) used in the cover assembly 120.

In an aspect, materials and/or colorings used for the fill layer 610 can be selected to preserve the overall appearance of the cover assembly 120. For example, the fill layer 610 can be composed of a transparent, or substantially transparent, material. As another example, material(s) can be chosen for the fill layer 610 such that the fill layer 610 approximately matches the color of the surrounding cover assembly 120. Also or alternatively, dyes, pigments, or the like can be applied to the material of the fill layer 610 such that the fill layer 610 matches the cover assembly 120 in appearance.

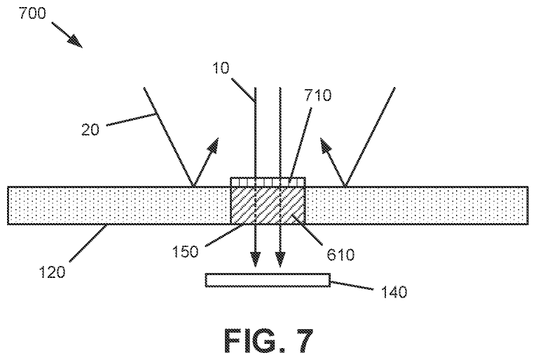

Referring next to FIG. 7, diagram 700 depicts a simplified cross-sectional view of still another implementation of an example wireless communication device, e.g., device 102 shown in FIG. 1. Repetitive description of like elements employed in other embodiments described herein is omitted for brevity. As shown in FIG. 7, a coating 710 can be applied to an exterior surface of the aperture 150, e.g., by applying the coating 710 to the fill layer 610. While the coating 710 has been enlarged in diagram 700 for illustrative purposes, it is noted that a thickness of the coating 710 can be sufficiently small such that the coating 710 does not noticeably alter the appearance or feeling of the cover assembly 120.

Similar to the fill layer 610 described above, the coating 710 can be composed of a non-reflective material, e.g., plastic, fiberglass, or the like. Additionally, the coating 710 can be composed of material(s) that preserve the overall appearance of the cover assembly 120 in a similar manner to the fill layer 610 as described above. Further, while the coating 710 is illustrated in diagram 700 as being applied to the entire fill layer 610, it is noted that the coating 710 could instead be applied to less than all of the fill layer 610. Also or alternatively, the coating 710 could in some implementations extend beyond the fill layer 610 to cover a portion of the cover assembly 120 surrounding the fill layer 610.

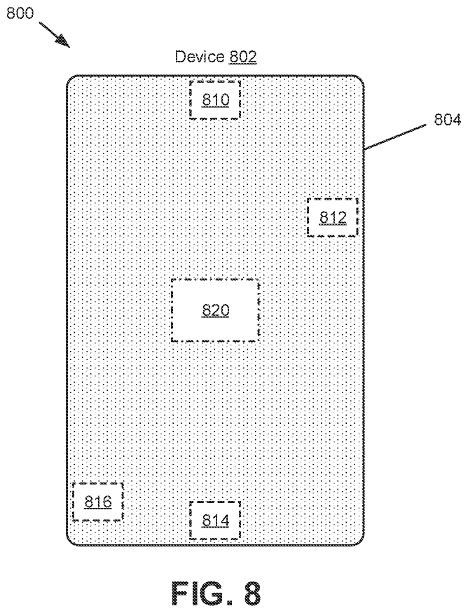

With reference now to FIG. 8, a diagram 800 depicting another wireless communication device 802 with improved performance via reduction in radio beam reflection is presented. Repetitive description of like elements employed in other embodiments described herein is omitted for brevity. In particular, diagram 800 is a top-down view of a single surface of the device 802, e.g., a back surface or other surface. As shown in diagram 800, the device 802 includes a device enclosure 804 that at least partially encompasses an interior of the device 802, e.g., in a similar manner to the device enclosure 110 shown in FIG. 1. Additionally, the device enclosure 804 defines a perimeter of the device 802, as shown in diagram 800 relative to a surface of the device 802.

As noted above, MIMO for network technologies such as LTE benefits from multiple paths, e.g., multiple paths caused by radio beam reflection, while the performance of beamforming is degraded by reflection. Accordingly, as shown in diagram 800, the device 802 can include one or more directional and/or beamforming antennas, here four directional antennas 810, 812, 814, 816, that are embedded in the device 802 and positioned inside the device enclosure 804 near the perimeter of the device 802, i.e., within a defined distance of the perimeter of the device 802. While diagram 800 depicts four directional antennas 810-816 that are positioned near respective edges of the device 802, it is noted that the device 802 could have any suitable number of directional antennas 810-816, including one directional antenna or multiple directional antennas. Additionally, it is noted that the relative positions of the directional antennas 810-816 shown in diagram 800 are merely examples of positions at which the directional antennas 810-816 could be placed and that other positions are also possible.

In some implementations, the directional antennas 810-816 can be placed physically adjacent to the edges of the device 802, e.g., such that the defined distance between the perimeter of the device 802 and the directional antennas 810-816 is approximately zero. Alternatively, the directional antennas 810-816 can be placed such that they are relatively adjacent to the edges of the device 802 (e.g., such that no other objects are placed between the directional antennas 810-816 and the edges of the device 802) and/or otherwise substantially adjacent to the edges of the device 802.

In an aspect, the directional antennas 810-816 can operate according to a given wireless communication technology (e.g., 5G, 6G, etc.) that utilizes beamforming and/or massive MIMO communication. By way of example, the directional antennas 810-816 can include C-Band antennas, mmWave antennas, and/or other suitable antenna elements for beamforming and/or massive MIMO communication.

As further shown in FIG. 8, the device 802 can include additional MIMO antenna(s) 820 that are positioned further from the perimeter of the device 802 than the directional antennas 810-816. Stated another way, the MIMO antenna(s) 820 can be positioned inside the device enclosure 804 at a defined distance from the perimeter of the device 802 that is greater than the distance between the directional antennas 810-816 and the perimeter of the device 802. While the MIMO antenna(s) 820 are depicted in diagram 800 as being located at a center point of the device 802, it is noted that the MIMO antenna(s) 820 could be placed at any suitable position, provided that the position of the MIMO antenna(s) 820 is farther from the edges of the device than the directional antennas 810-816.

In an aspect, the MIMO antenna(s) 820 can operate according to a different wireless communication technology than that of the directional antennas 810-816, e.g., LTE, Wi-Fi, and/or other suitable technologies. Accordingly, the MIMO antenna(s) 820 can in some implementations be larger than the directional antennas 810-816. Additionally, as the MIMO antenna(s) 820 are positioned near the center of the device 802, the MIMO antenna(s) 820 can benefit from multiple paths caused by reflections from any present neighboring devices, while radio beam reflection near the edges of the device at the positions of the directional antennas 810-816 can be mitigated.

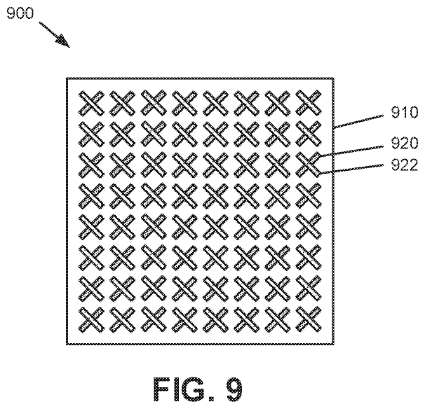

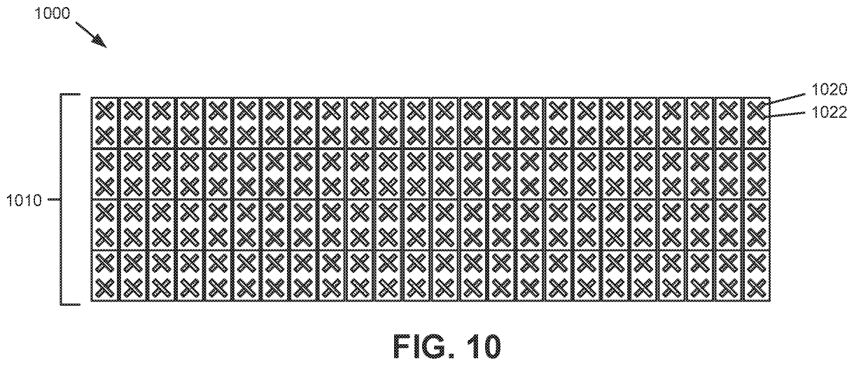

With reference now to FIGS. 9-10, respective examples of antenna configurations that can be utilized by a transmitter device, e.g., a gNB or a similar device, are presented. It is noted that the antenna configurations illustrated by FIGS. 9-10 are merely examples of antenna configurations that could be used and that other configurations are also possible.

Turning to FIG. 9, a diagram 900 depicting an example C-Band antenna panel 910 that can be utilized by a cellular transmitter device, e.g., a gNB, is presented. As shown in diagram 900, the antenna panel 910 includes 128 antenna elements 920, 922, which are arranged in an eight-by-eight array of antenna element pairs. Accordingly, the antenna panel 910 can support up to 64 beams, i.e., one beam for each antenna element pair.

As further shown in diagram 900, each antenna element pair contains a vertical antenna element 920 and a horizontal antenna element 922 overlaid onto each other in a cross formation, i.e., such that each vertical antenna element 920 is rotated 90 degrees relative to its corresponding horizontal antenna element 922. As a result of this relative positioning, the horizontal and vertical antenna elements of a given antenna element pair produce waveforms that are displaced 90 degrees against each other, which in turn enables horizontal and vertical polarization for received signals, respectively.

In an embodiment, the antenna panel 910 can enable communication of approximately 2 layers per user. Additionally, each antenna element 920, 922 has an overall size on the order of a few millimeters. The small size of the antenna elements 920, 922, coupled with the number and formation of the antenna elements 920, 922 on the antenna panel 910, can enable communication of approximately four layers per user, with a beam width of approximately 15 degrees.

Referring next to FIG. 10, a diagram 1000 depicting an example mmWave antenna panel 1010 that can be utilized by a cellular transmitter device, e.g., a gNB, is presented. Repetitive description of like elements employed in other embodiments described herein is omitted for brevity. The mmWave antenna panel 1010 shown in diagram 1000 includes respective pairs of antenna elements 1020, 1022, which can function in a similar manner to the antenna elements 920, 922 described above with respect to FIG. 9. Here, the antenna element pairs are arranged in a 24-by-8 array, for a total of 192 antenna element pairs, which enables the antenna panel 1010 to support up to 192 beams.

In an embodiment, the antenna panel 1010 can enable communication of approximately 2 layers per user in a similar manner to the antenna panel 910 shown in FIG. 9. Additionally, the overall size of the antenna elements 1020, 1022 can be smaller than that of the antenna elements 920, 922, e.g., approximately 1 to 10 mm. Additionally, the increased number of antenna element pairs of the mmWave antenna panel 1010 as compared to the C-Band antenna panel 910 can enable the mmWave antenna panel 1010 to enable beams of a sharper width, e.g., beams of approximately 3 degrees.

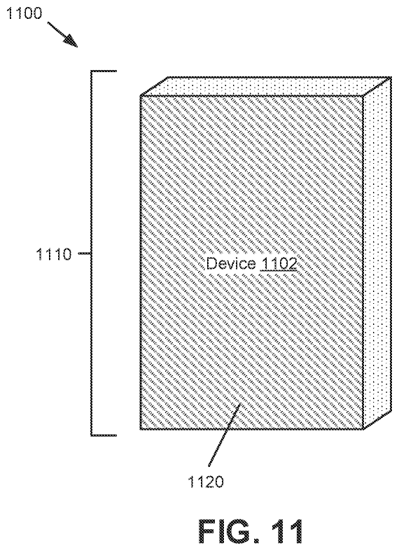

With reference now to FIG. 11, a diagram 1100 depicting an additional wireless communication device 1102 with improved performance via reduction in radio beam reflection is presented. Repetitive description of like elements employed in other embodiments described herein is omitted for brevity. The wireless communication device 1102 shown in diagram 1100 includes a device enclosure 1110, which can function similarly to the device enclosure 110 described above with respect to FIG. 1. As further shown by diagram 1100, the device 1102 can include a cover assembly 1120 that is composed of one or more non-reflective materials, such as plastic, metal, fiberglass, or the like. While the cover assembly 1120 shown in diagram 1100 can reduce the incidence of reflected radio beams observed by the device 1102, the performance of antennas associated with the device 1102 that benefit from multiple paths created by neighboring devices, if present, via reflection could be reduced compared to other embodiments as described herein. Additionally, the utilization of a separate material for the entire cover assembly 1120 could be undesirable in some cases due to its appearance, e.g., in comparison to the appearance of glass or other reflective materials.

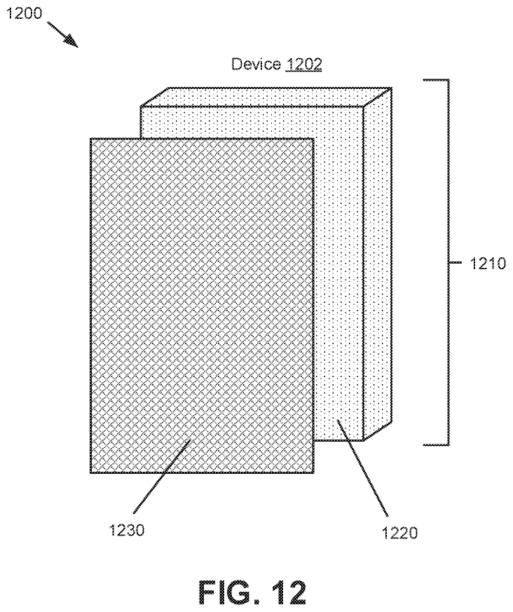

Turning to FIG. 12, a diagram 1200 depicting a partially exploded view of a further wireless communication device 1202 with improved performance via reduction in radio beam reflection is presented. Repetitive description of like elements employed in other embodiments described herein is omitted for brevity. The device 1202 shown in diagram 1200 includes a device enclosure 1210, which can be composed of a reflective material (e.g., glass, etc.) in a similar manner to the device enclosure 1110 shown in FIG. 11.

In contrast to FIG. 11, the cover assembly 1220 of the device 1202 is composed of the same material(s) as the remainder of the device enclosure 1210. To facilitate a reduction in radio beam reflection, a non-reflective coating 1230 can be applied to the cover assembly 1220 of the device 1202. The non-reflective coating 1230 can be composed of and/or include paints or other pigments, resins, and/or other materials having lower reflectivity than the cover assembly 1220. However, similar to the device 1102 in FIG. 11, the application of a non-reflective coating 1230 to an entire surface of the device 1202 could be undesirable due to appearance and/or for other reasons. To mitigate this, the coating 1230 could be selectively applied to portions of the cover assembly 1220, e.g., portions of the cover assembly 1220 at which antenna panels are embedded in the device 1202.

By implementing various embodiments as described herein, various advantages can be realized that can improve the performance of a wireless communication device and/or an associated wireless communication network. For instance, while power and/or energy is spread out among an entire cell in LTE networks, beamforming focuses power and/or energy among radio beams. By reducing beam reflection where beamforming operates, interference observed from cells can be reduced, each of which can radiate up to 192 beams in present implementations. Additionally, when interference and noise are reduced, overall beamforming performance can similarly improve. For instance, as shown in FIGS. 2-3, C-Band beamforming performance can be improved by approximately 30 to 40 percent by reducing radio beam reflection, which can correspond to a similar improvement in spectrum efficiency. Greater benefits could also be realized for mmWave due to the increased number of beams utilized by mmWave compared to C-Band.

Further, reduction in radio beam reflection can benefit not only a given device but also neighboring devices, which can receive fewer non-line-of-sight beams via reflection. This can also result in a reduction in radio beam pollution in city centers and/or other crowded urban areas. As another advantage, reducing radio beam pollution could improve the feasibility of Multi-User MIMO (MU-MIMO), which would multiply cell throughput. Larger devices, such as laptop computers, tablets, or the like, could also benefit from beam reflection reduction to a greater extent than smaller devices, e.g., due to increased space for antenna rearrangement or the like. Other advantages are also possible.

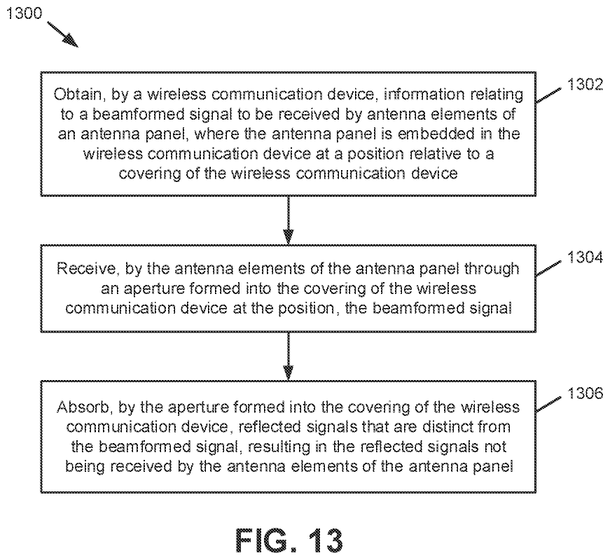

With reference now to FIG. 13, a flow diagram of a method 1300 that facilitates improvement in wireless communication device performance via reduction in radio beam reflection is presented. At 1302, a wireless communication device (e.g., a wireless communication device 102) can obtain information relating to a beamformed signal to be received by an antenna (e.g., an antenna 140). Here, the antenna is embedded in the device at a position relative to a covering (e.g., a cover assembly 120) of the device.

At 1304, the antenna can receive, through an aperture (e.g., an aperture 150) formed into the covering of the device, the beamformed signal without reflecting, by the covering of the device, the beamformed signal.

FIG. 13 illustrates a method in accordance with certain aspects of this disclosure. While, for purposes of simplicity of explanation, the method is shown and described as a series of acts, it is noted that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain aspects of this disclosure.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A wireless communication device, comprising:
a device enclosure that at least partially encompasses an interior of the wireless communication device, the device enclosure comprising a cover assembly that defines a surface of the wireless communication device, wherein the cover assembly is composed of at least a first material;
an antenna embedded within the interior of the wireless communication device substantially adjacent to the cover assembly, wherein the antenna is situated at a position relative to the cover assembly; and
an aperture formed into the cover assembly at the position, wherein the aperture is not composed of the first material.

2. The wireless communication device of claim 1, wherein the first material is glass.

3. The wireless communication device of claim 1, wherein the aperture is filled with a second material that is distinct from the first material.

4. The wireless communication device of claim 3, wherein the second material is selected from a group comprising fiberglass and plastic.

5. The wireless communication device of claim 3, wherein the second material is transparent, or substantially transparent.

6. The wireless communication device of claim 1, wherein the surface of the wireless communication device is a first surface, and wherein a second surface of the aperture, opposite the interior of the wireless communication device, is coated with a non-reflective material.

7. The wireless communication device of claim 1, wherein the antenna is a first antenna, wherein the device enclosure defines a perimeter of the wireless communication device, wherein the position is a first distance from the perimeter of the wireless communication device, and wherein the wireless communication device further comprises:
a second antenna, distinct from the first antenna, embedded within the interior of the wireless communication device and positioned at a second distance, greater than the first distance, from the perimeter of the wireless communication device.

8. The wireless communication device of claim 7, wherein the second antenna is positioned at a center point, or substantially the center point, relative to the perimeter of the wireless communication device.

9. The wireless communication device of claim 1, wherein the wireless communication device is selected from a group comprising a mobile phone, a virtual reality headset, a computer, and a vehicle communication system.

10. The wireless communication device of claim 1, wherein the antenna is selected from a group comprising a C-band antenna and a millimeter wave antenna.

11. A wireless communication device, comprising:
a device enclosure that at least partially encompasses an interior of the wireless communication device, wherein the device enclosure defines a perimeter of the wireless communication device;
a directional antenna embedded within the wireless communication device and positioned inside the device enclosure at a first distance from the perimeter of the wireless communication device, wherein the directional antenna operates according to a first wireless communication technology; and
a multiple-input multiple-output antenna, distinct from the directional antenna, positioned inside the device enclosure at a second distance, greater than the first distance, from the perimeter of the wireless communication device, wherein the multiple-input multiple-output antenna operates according to a second wireless communication technology that is distinct from the first wireless communication technology.

12. The wireless communication device of claim 11, wherein the multiple-input multiple-output antenna is positioned at a center point, or substantially the center point, relative to the perimeter of the wireless communication device.

13. The wireless communication device of claim 11, wherein the device enclosure further defines respective edges of the wireless communication device, wherein the directional antenna is a first directional antenna, and wherein the wireless communication device further comprises:
a group of directional antennas, comprising the first directional antenna, positioned substantially adjacent to respective ones of the edges of the wireless communication device.

14. The wireless communication device of claim 11, wherein the directional antenna is selected from a group comprising C-band antennas and millimeter wave antennas.

15. The wireless communication device of claim 11, wherein the first distance is approximately zero.

16. The wireless communication device of claim 11, wherein the device enclosure is composed of at least a material, wherein the directional antenna is situated at a position relative to the device enclosure, and wherein the wireless communication device further comprises:
an aperture formed into the device enclosure at the position, wherein the aperture is not composed of the material.

17. The wireless communication device of claim 11, wherein the wireless communication device is selected from a group comprising a mobile phone, a virtual reality headset, a computer, and a vehicle communication system.

18. A method, comprising:
obtaining, by a wireless communication device, information relating to a beamformed signal to be received by an antenna of the wireless communication device, wherein the antenna is embedded in the wireless communication device at a position relative to a covering of the wireless communication device; and
receiving, by the antenna through an aperture formed into the covering of the wireless communication device at the position, the beamformed signal without reflecting, by the covering of the wireless communication device, the beamformed signal.

19. The method of claim 18, further comprising:
absorbing, by the aperture formed into the covering of the wireless communication device, reflected signals that are distinct from the beamformed signal.

20. The method of claim 18, wherein the antenna is a first antenna, and wherein the method further comprises:
receiving, by a second antenna, embedded in the wireless communication device and distinct from the first antenna, a non-beamformed signal that is distinct from the beamformed signal.
